(19) United States
(12) Patent Application Publication
(10) Pub. No.: US 2011/0032124 A1
(43) Pub. Date: Feb. 10, 2011

(54) TAXIWAY AIRCRAFT LOCATION MONITORING SYSTEM

(76) Inventor: John Baskin, Renton, WA (US)

Correspondence Address: DEAN A. CRAINE, 9-Lake Bellevue Drive, Suite 208, BELLEVUE, WA, 98005, US

(21) Appl. No.: 12/853,890

(22) Filed: Aug. 10, 2010

Related U.S. Application Data
(60) Provisional application No. 61/232,481, filed on Aug. 10, 2009.

(51) Int. Cl. G08G 5/04

(52) U.S. Cl. 340/961

(57) ABSTRACT

A taxiway aircraft location monitoring system that includes an aircraft transceiver unit located in an aircraft designed to selectively communicate with the second transceiver unit located in the control tower and with other aircraft moving on the airport. Each transceiver unit is coupled to the aircraft's global positioning system (GPS) used to determine the current location and altitude. During operation, the aircraft's transceiver unit transmits the aircraft's FAA assigned registration number and current location to a receiving unit located in the control tower and other transceiver units located in other aircrafts. The aircraft's transceiver unit is coupled to a control switch that constantly monitors the aircraft's current altitude its distance from the airport's control tower so that the control switch automatically activates and deactivates the transmission of wireless signals from the aircraft's transceiver unit when the aircraft is within or outside a predetermined altitude or distanced from the control tower. The transceiver units may be coupled to displays with maps showing all of the runways and taxiways at the airport and the current location of any aircraft moving on the ground.

This utility patent application is based on and claims the filing date the provisional patent application (Ser. No. 61/232,481) filed on Aug. 10, 2009.

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to systems used to monitor the location of an object in a specific area or region, and more particularly to system used to monitor the location of aircraft moving in the taxiways and runways of an airport.

2. Description of the Related Art

Large and medium size airports usually have control towers that use radar to track the location of airborne aircraft departing and arriving at the airport. When the aircraft is on the ground, radar tracking of the aircraft's location on the ground is not used. Pilots in command of the aircraft must look out through the cockpit's windows and manually steer the aircraft to the desired runway for take off or to the desired gate for de-boarding. In most instances, visibility is clear and pilots know which runway and taxiway to use. However, during inclement weather, the pilot's vision may be impaired and pilots may be directed by controllers to use an alternate runway or taxiway.

Unfortunately, driving and instruction errors can occur that can cause two aircraft on the ground to collide. What is needed is a monitoring system specifically designed to prevent these sorts of collisions.

### SUMMARY OF THE INVENTION

It is an object of the present invention to provide a monitoring system for aircraft moving on taxiways and runways on a controlled airport.

It is another object of the present invention to provide such a monitoring system that can be used by most control towers and most aircraft.

These and other objects are met by the taxiway aircraft location monitoring system that includes a transceiver unit located in an aircraft. The transceiver unit is coupled to the aircraft's global positioning system (GPS) is used to determine the current location and altitude of the aircraft. During operation, the transceiver unit transmits the aircraft's FAA assigned registration number and the aircraft's current GPS's determined location to a second transceiver unit located in the airport's control tower or to a transceiver unit located in another aircraft. Both aircraft's transceiver units are coupled to a control switch that constantly monitors the aircraft's current altitude and/or its distance from the airport's control tower. The control switch automatically transmission of signals from activates and deactivates the aircraft's transceiver unit when the aircraft is within or outside a predetermined altitude or distance from the control tower.

In the first embodiment, both transceiver units are coupled to displays in which a map of the runways and taxiways at the airport is shown. When an aircraft is within range and a preselected altitude of the control tower, the aircraft's location and altitude is visually indicated on maps shown on the displays. When two aircrafts are on a collision course, alarms in the two aircrafts and in the control tower are automatically activated.

The system may include a second aircraft transceiver unit as a backup unit in the event the first transceiver unit fails.

### DESCRIPTION OF THE DRAWINGS

FIG. 1 is a top plan illustration of an airport with a control tower monitoring the movement of one aircraft on a runway and movement of a second aircraft on an intersecting taxiway.

FIG. 2 is a side elevation illustration of an aircraft and control tower that uses the aircraft location monitoring system disclosed herein.

FIG. 3 is a block diagram of components used in an aircraft and control tower used with the aircraft location monitoring system.

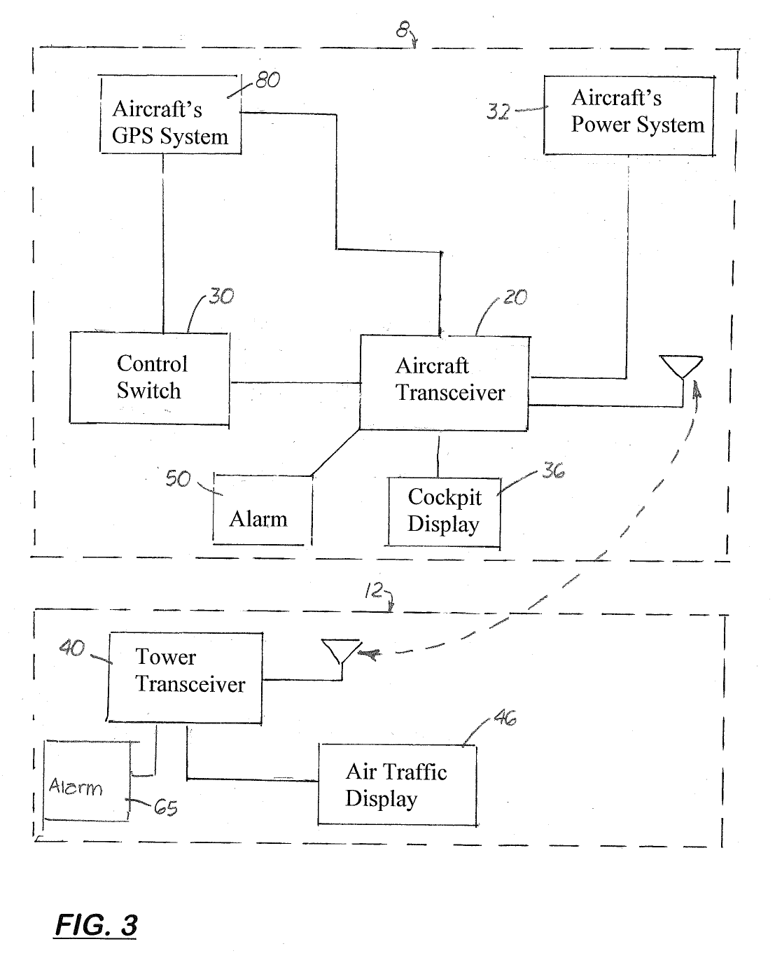

### DESCRIPTION OF THE PREFERRED EMBODIMENT(S)

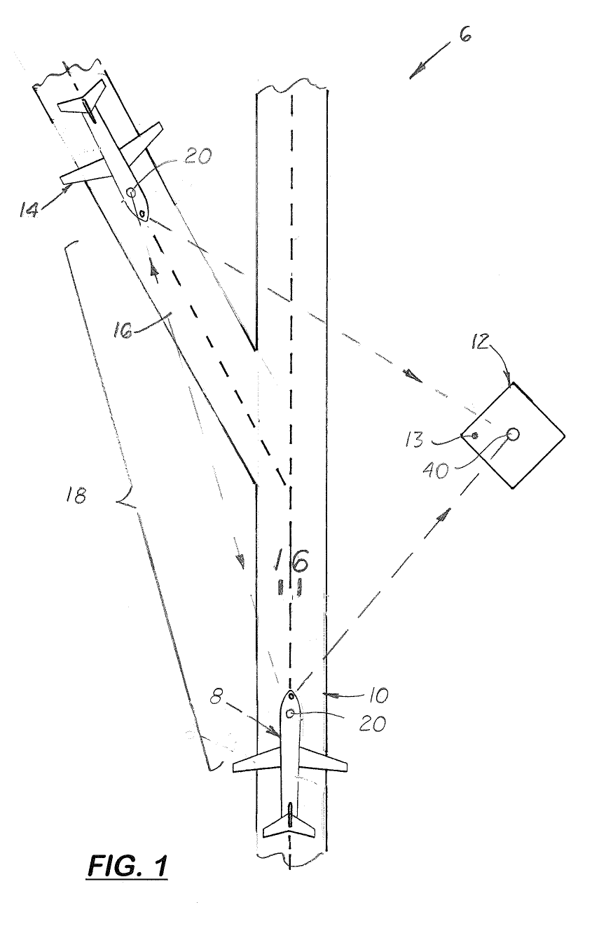

Referring to the accompanying FIG. 1 is a top plan illustration of an airport 6 with a control tower 12 monitoring the movement of one aircraft 8 on a runway 10 and the movement of a second aircraft 14 on an intersecting taxiway 16. The system 18 disclosed herein is used to prevent collisions of the two aircrafts 8, 14 in the event the pilots of the aircrafts 8, 14 do not see each other, or the air traffic controller 13 in the control tower 12 does not visually monitor the movement of the aircraft 8, 14 on the airport's runway 10 and taxiway 16.

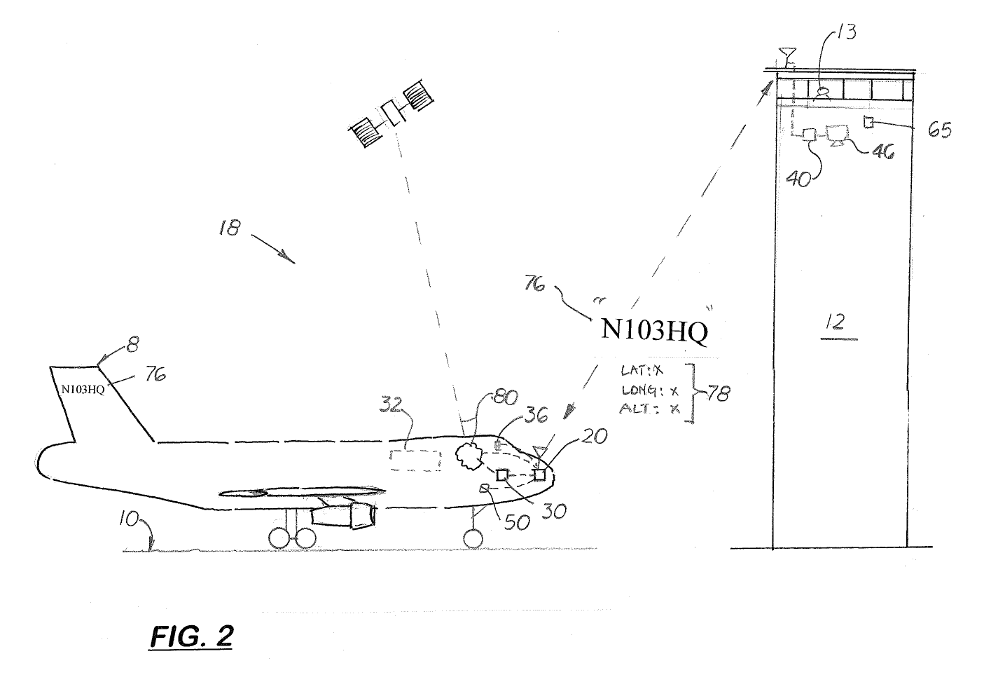

As shown in FIG. 2, the aircraft location monitoring system 18 includes a wireless transceiver unit 20 located in an aircraft 8. The transceiver unit 20 is coupled to the aircraft's global positioning system (GPS) 80 which is used to determine the current location and altitude of the aircraft 8. During operation, the transceiver unit 20 when activated to broadcast a radio signal is programmed to continuously transmit the aircraft's FAA assigned registration number 76 and the aircraft's current GPS's determined location 78 to a second transceiver unit 40 located in the control tower 12. The aircraft's transceiver unit 20 is coupled to a control switch 30 that constantly monitor's the aircraft's current altitude and/or its distance from the airport's control tower 96. The control switch 30 automatically activates and deactivates transmission of the data from the transceiver unit 20 when the aircraft 8, 14 is within or outside a predetermined altitude (i.e. 1,000 feet), or distanced (i.e. 5,000 feet), from the control tower 96.

The aircraft's transceiver 20 and the second transceiver 40 must be compatible for wireless communication to take place between them. Both transceivers 30, 40 may be coupled to a cockpit display 36 or control tower display 46, respectively with maps shown thereon of the runways 10 and taxiways 16 at the airport 6. During operation, the current location of any aircraft 8, 14 moving on the ground is displayed on the two displays, 36, 46.

In the preferred embodiment, the transceivers 20 are designed to broadcast on the same frequency so that signals from the transceivers in the aircraft may be received by the transceiver in the other aircraft.

In the preferred embodiment, visual or audible alarms 50, 65 is provided in the aircrafts 8, 14 and control tower 12 when the two aircrafts 8, 14 are within a predetermined distance (such as 3,000 feet), of each other. In the preferred embodiment, the transceiver unit 20 and control switch 30 are designed to connect to the aircraft's electrical system 38 so that it is automatically activated when the aircraft's electrical system 38 is activated.

The system 18 may include a second aircraft transceiver unit 20′ (shown located in the aircraft's vertical stabilizer) which may be used as a backup transceiver unit in the event the first transceiver unit 20 fails.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A taxiway aircraft location monitoring system, comprising:
a. an airport with a control tower with monitoring stations location therein used to monitor and instruct outboard and inboard aircraft to said airport; said monitoring station includes a display with a map showing the runways and taxiways at said airport;
b. an aircraft with an on-board GPS system used to determine the current location and altitude of said aircraft said aircraft being assigned a unique registration number;
c. an aircraft transceiver unit located inside said aircraft and coupled so said global positioning system, said transceiver unit to continuously transmit the aircraft's location and to monitor the relative distance or elevation from said control tower;
d. a control tower transceiver unit located in said control tower designed to receive the wireless signals from said transceiver unit inside said aircraft when activated, said receiving unit being coupled to said display at said monitoring station so that all of the runways and taxiways at the airport and the current location of any aircraft moving on the ground;
e. a switch coupled to said aircraft transceiver unit used to activate and deactivate the transmission of wireless signals from said aircraft transceiver unit when the aircraft is within or outside of a predetermined altitude or distance from said control tower; and,
f. an alarm located in said aircraft to provide a warning when said aircraft is on a collision coarse with another aircraft when moving on the ground on said airport.
